(19) United States
(12) Patent Application Publication
(10) Pub. No.: US 2007/0056898 A1
(43) Pub. Date: Mar. 15, 2007

(54) Ablated predetermined surface geometric shaped boundary formed on porous material mounted on a substrate and methods of making same

(76) Inventors: Keith Wesner, East Hampton, CT (US); Aaron Spearin, Colchester, CT (US); Mark T. Meyering, Middletown, CT (US); Douwe D. Haga, Emerald Hills, CA (US); Julio Focaracci, San Mateo, CA (US); Nelson G. Todd, San Mateo, CA (US); Janusz B. Wojtowicz, Sunnyvale, CA (US)

Correspondence Address: 3M INNOVATIVE PROPERTIES COMPANY, PO BOX 33427, ST. PAUL, MN, 55133-3427, US

(21) Appl. No.: 11/363,630

(22) Filed: Feb. 28, 2006

Related U.S. Application Data
(63) Continuation of application No. 11/129,685, filed on May 13, 2005.
(60) Provisional application No. 60/571,446, filed on May 13, 2004.

(51) Int. Cl. B01D 29/00

(52) U.S. Cl. 210/490; 210/500.27; 435/288.3; 264/41

(57) ABSTRACT

The present disclosure relates to processes and methods for producing a hydrophobic zone boundary that surrounds a hydrophilic porous material layer mounted on a substrate, the hydrophilic porous material layer containing tortuous channels and pores such that the fluid contained within one hydrophilic layer region does not cross the hydrophobic zone boundary and the articles formed thereby and, more particularly, to processes and methods for producing a hydrophobic zone boundary that separates adjacent regions of a hydrophilic porous material layer mounted on a substrate, the hydrophilic porous material layer containing tortuous channels and pores mounted on a substrate such that a uniform hydrophobic zone boundary layer in the z-direction is formed in the hydrophilic porous material or the removal of the hydrophilic porous material layer from the substrate to form a hydrophilic porous material zone on the substrate, the so formed hydrophilic porous material zone having a predetermined geometric shape such that the combination produced thereby is useful in microarray applications and other applications. Products of the processes and methods are also disclosed.

### RELATED APPLICATIONS

This application is a continuation-in-part of U.S. Provisional Application No. 60/571,446, of Meyering et al., filed on May 13, 2004 and is related to commonly owned U.S. patent application Ser. No. 10/410,709 of Keith Solomon et al., filed on Jul. 3, 2001, entitled “Improved Composite Microarray Slides,” now US Publication No. 2003 0219816, the disclosure of each is herein incorporated by reference to the extent not inconsistent with the present disclosure.

### BACKGROUND OF THE DISCLOSURE

The present disclosure relates to processes and methods for producing a hydrophobic zone boundary that surrounds a hydrophilic porous material layer mounted on a substrate, the hydrophilic porous material layer containing tortuous channels and pores such that the fluid contained within one hydrophilic layer region does not cross the hydrophobic zone boundary and the articles formed thereby and, more particularly, to processes and methods for producing a hydrophobic zone boundary that separates adjacent regions of a hydrophilic porous material layer mounted on a substrate, the hydrophilic porous material layer containing tortuous channels and pores mounted on a substrate such that a uniform hydrophobic zone boundary layer in the z-direction is formed in the hydrophilic porous material or the removal of the hydrophilic porous material layer from the substrate to form a hydrophilic porous material zone on the substrate, the so formed hydrophilic porous material zone having a predetermined geometric shape and, most particularly, to processes and methods for producing a hydrophobic zone boundary that separates adjacent regions of a hydrophilic porous material mounted on a substrate, the hydrophilic porous material containing tortuous channels and pores mounted on a substrate such that a uniform hydrophobic zone boundary layer in the z-direction is formed in the hydrophilic porous material or the removal of the hydrophilic porous material from the substrate, the hydrophobic zone boundary having a predetermined geometric shape formed by the ablation of the porous polymer membrane attached to the solid substrate in order to provide a uniform surface for gasket sealing, and fluid retention, the predetermined surface geometric shape being formed by the ablation of the porous polymer membrane attached to the solid substrate in order to provide a uniform surface for gasket sealing and fluid retention, such that the combination produced thereby is useful in microarray applications and other applications and to processes and methods for producing predetermined surface geometric shapes by the ablation of the hydrophilic porous polymer membrane attached to a solid substrate in order to provide a uniform surface for gasket sealing, and fluid retention such that the combination produced thereby is useful in microarray applications and other applications.

As is known, nylon membrane is a hydrophilic porous material, containing tortuous channels and pores for fluid flow and filtration. A membrane surface is less uniform in the z-direction and does not provide as suitable a surface for sealing as a flat film (such as, for example, polyester film/Mylar®). The pore structure and hydrophilic character of nylon membrane promotes seepage of liquids in a lateral flow mode, which causes liquid to flow under a gasket. Therefore, a compressed gasket on a hydrophilic nylon membrane surface does not provide a sufficient boundary layer to contain fluid within a gasket sealed area. Because of the porous nylon membrane surface and porous path remaining under the compressed gasket, fluid dispensed within the gasket area, will leak beyond the predetermined boundary layer area. Providing a hydrophobic zone, a uniform boundary layer in the z-direction, or removal of the nylon porous surface having a defined geometric shape, under the gasket area of the nylon membrane surface is needed to prevent significant loss of a dispensed fluid within the boundary area during operations.

Prior art is known concerning methods for creating regions of separate hydrophilic and hydrophobic zones. However, the present inventors are unaware of any prior art directed to methods for forming predetermined shaped zones that separate hydrophilic and hydrophobic zones of a porous material on a substrate that have proven to be user friendly with respect to prior micro-array platforms. Specifically, none have been found that have been successful in applying a gasket for containing fluid within the predetermined hydrophilic zone, or modifying the surface with an ablation process to define the hydrophilic zone boundary.

There are prior known patents that speak to the problem of isolating individual spots from its surrounding spots or zones. Zones are predetermined as hydrophilic and hydrophobic. The process disclosed is micro-array and membrane specific, with a predetermined use of a hydrophilic/hydrophobic boundary.

However, none of the following patents appear to be concerned with the concept of a fluid containment seal, created by the ablation of the micro porous material formed on the substrate, creating a hydrophobic zone to contain fluid and for the placement of a supporting gasket. Specifically, the following patents/publications are believed to be somewhat representative.

Publication No. 2001020330/WO-A1, entitled “SPATIALLY ADDRESSED LIPID BILAYER ARRAYS AND LIPID BILAYERS WITH ADDRESSABLE CONFINED AQUEOUS COMPARTMENTS,” by CREMER, et al., published Mar. 22, 2001;

Publication No. WO 03/004993, entitled “Satterned Composite Membrane and Stenciling Method for the Manufacture Thereof,” Kopaciewicz, William filed 8 Jul. 2002, Applicant, Millipore Corporation;

U.S. Pat. No. 6,720,149 B1 entitled “Methods for Concurrently Processing Multiple Biological Chip Assays,” Rava et al., filed May 28, 2002, Assignee, Affymetrix, Inc.;

Publication No. 2003049851/WO-A2, entitled “MICROAR AY DEVICE,” by FISCHER-FRUHHOLZ, Stefan, et al. DATE FILED-2002-11-22 APPLICANT(S), SARTORIUS AG;

“Wedge-shaped ceramic membranes for gas sensor applications produced by a variety of CVD techniques,” published in, Surface and Coating Technology, Vol. 120-1.21, 1999, authors, Frietsch, M.; Dimitrakopoulos, L. T.; Schneider, T.; Goschnick, J.; and

Publication No. 2002048676/W0-A3, entitled “MULTIPLE ARRAY SYSTEM FOR INTEGRATING BIOARRAYS,” INVENTOR(S)-KIM, Enoch; DUFFY, David DATE FILED-2001, Nov. 07 APPLICANT(S)—SURFACE LOGIX, INC.

During the present development, several methods were investigated with the intention of creating separate, hydrophobic zones having a predetermined shape formed on the microarray surface, in order to contain fluid within the hydrophilic area separated by the hydrophobic boundary, and for gasket placement during operations. These methods included, but were not limited to:

1) Filling a predetermined number of pores with a specific surface geometric shape on the supported substrate with acrylic adhesives, such as, for example, Adcote.

2) Filling a predetermined number of pores with a specific geometric shape on the supported substrate with a self-curing elastomers (such as, for example, a liquid caulk);

3) Dissolving the predetermined number of pores with a specific geometric shape with an acid; (such as, for example, formic acid) to ablate the surface of the porous media;

4) Use of ultrasonic welding or impulse heating to ablate the supported surface of the composite slide;

5) Mechanically crushing the pores to prevent liquid seepage outside the predetermined boundary;

6) Masking the glass before applying an epoxy, with a pattern, then cutting the nylon in the desired pattern by a laser prior to peeling nylon from the portions of the glass having no epoxy.

Embossing or etching substrates such as chips, or wafers, with predetermined geometric channels is known in several defined processes. Microporous membrane is placed on the preformed substrates, and then thermally bonded. The surface of the channels is then oxidized to make them hydrophobic. This allows for channels to be predetermined on the substrate, with hydrophobic and hydrophilic regions but none involves bonding the microporous membrane to the support substrate and then ablating the surface to form separate, hydrophobic zones having a predetermined shape formed thereon to provide the gasket and containment area for the application fluid.

US Publication No. 20030180711/US-A1, filed-Feb. 21, 2003 discloses a three dimensional microfluidic device that is formed by placing a membrane between two micropatterned chips. The membrane is positioned to cover the area where channels intersect. In one specific embodiment, the membrane is porous. The chips are formed of plastic, and are thermally bonded under pressure. Reservoirs are formed on the chips at each end of each channel. The channels are created in the chip by use of an embossing master, such as a patterned silicon wafer. The reservoirs are formed by drilling. A hydraulic press is used to emboss both chips, and is also used to thermally bond the chips and membrane under pressure. The surfaces of the channels are oxidized, changing the surfaces from hydrophobic to hydrophilic.

European patent No. 0697377/EP-B1, filed Aug. 18, 1994, discloses a process for production of a glass substrate coated with a patterned Nesa glass membrane which comprises, in sequence: the first step of coating a photoresist on a glass substrate to form a photoresist membrane, exposing the membrane to electromagnetic waves through a mask and then developing the photoresist to form a patterned photoresist membrane on the glass substrate; the second step of forming a Nesa glass membrane on the entire surface of the glass substrate thus provided with the patterned photoresist membrane; and the third step of removing the patterned photoresist membrane together with the Nesa glass membrane thereon from the glass substrate to leave a patterned Nesa glass membrane on the glass substrate. Nesa glass has an electrically conductive surface in the treated area, used for glass electrode measurements. It is not designed for fluid retention on its surface or a hydrophobic boundary, nor affecting a seal.

Thus, there is a continuing need for an article and methods of making an article having a hydrophobic zone boundary that surrounds a hydrophilic porous material region or zone, the hydrophobic zone boundary being formed on the surface of the hydrophilic porous material, and or a hydrophobic zone boundary that separates adjacent regions of a hydrophilic porous material mounted on a substrate, the hydrophilic porous material containing tortuous channels and pores such that the fluid contained within one hydrophilic region does not cross the hydrophobic zone boundary into any adjacent region and the articles formed thereby.

More specifically there is also a continuing need for relatively flat, uniform and thin, hydrophilic porous material having a hydrophobic zone boundary that surrounds and/or separates adjacent hydrophilic regions formed on the hydrophilic porous material mounted on a composite microarray slide, the hydrophobic zone boundary having a predetermined surface geometric shape for providing a uniform surface for gasket sealing, and fluid retention within the predetermined hydrophilic zone useful for Micro-Analytical Diagnostic Applications. Such composite microarray slides should substantially reduce, if not eliminate, leakage of solutions containing biological polymer (i.e., analytes including but not limited to nucleic acids or proteins), or leakage of reagents that effect the detection of analytes positioned on the surface of the composite microarray slide.

### SUMMARY OF THE DISCLOSURE

It should be understood that the innovative processes and innovative products of the processes have greater application than the specific improved composite microarray slides for microarray analysis, which is merely being used as the vehicle thought which these innovations are being described in the present disclosure. The specifically disclosed representative improved composite microarray slides for microarray analysis of the present disclosure include a predetermined surface geometric shape for providing a uniform surface for gasket sealing, and fluid retention within the predetermined geometric area, the predetermined surface boundary geometric shape being, presently preferably, formed by the ablation of the porous polymer membrane attached to the solid substrate for providing a uniform surface for gasket sealing, and fluid retention within the predetermined geometric area.

In the presently preferred process, which results in a product useful for microarrays (gene and protein expression and detection analysis), the presently preferred end product is a composite of microporous membrane, presently preferably, nylon microporous membrane operatively mounted on a non-porous substrate, presently preferably, a glass slide by a presently preferably proprietary attachment method, which is disclosed in commonly owned U.S. patent application Ser. No. 10/410,709 of Keith Solomon et al., filed on Jul. 3, 2001, entitled “Improved Composite Microarray Slides,” or a composite microarray slide. Although the microporous membrane covers one whole slide of the substrate, there are predetermined areas on the surface of the microporous membrane which are active and must be exposed to a variety of chemistries. The microporous membrane is hydrophilic.

During operation of the composite microarray slides in the intended environment, certain areas of the surface of the composite microarray slides must remain dry. To isolate the areas, the new and innovative process will selectively “ablate” the pore structure, rendering it non-porous and/or hydrophobic or removing material containing the pore structure entirely from the glass.

The presently preferred process comprises representative methods for obtaining hydrophobic/ablated patterns in the composite microarray slide's membrane/composite structure. These hydrophobic/ablated patterns define geometric shapes which will effectively isolate any fluid contained within the predetermined geometric boundary.

The new and innovative process for producing new and innovative products comprises keeping the hydrophilic area hydrophilic, and interrupting the pore structure around the hydrophilic area for containing a fluid therein. Through the use of interrupted pore structure to form hydrophobic/ablated patterns, the surrounded hydrophilic area can be made into patterns/shapes which are useful for such fluid containment.

One object of the present disclosure is to provide commercially useful composite microarray slides having a solid substrate and a porous membrane, the exposed porous membrane surface having a predetermined geometric area defined by hydrophobic boundaries operatively formed thereon which will retain or transport fluids within the predetermined hydrophilic geometric area used in specific representative applications such that the combination produced thereby is useful in microarray applications.

Another object of the present disclosure is to provide commercially useful composite microarray slides having a solid substrate and a porous membrane, the exposed hydrophilic porous membrane surface having a predetermined geometric area defined by hydrophobic boundaries operatively formed thereon, the hydrophobic boundaries being operative to transport fluids between various predetermined geometric areas used in specific representative applications.

In one presently preferred representative embodiment, the porous membrane is nylon and the substrate is glass, and the predetermined hydrophilic geometric area is intended to retain liquid hybridization buffers, wash buffers, etc as needed for nucleic acid expression analysis (i.e. microarray).

In an alternative representative embodiment, a porous polymer is attached to a solid substrate, and the predetermined hydrophobic boundaries operatively formed thereon are designed to facilitate fluid transport in channels, such as micro channel reactors.

In other alternative embodiments, the predetermined hydrophobic boundaries operatively formed thereon are patterned for channel chromatography, or membrane based micro fluidics.

Many unique products can be envisioned for predetermined geometries formed by membrane ablation on a solid substrate. The immediate objective of nylon ablation with a predetermined geometric shape for a membrane laminated glass substrate is to provide a uniform boundary for gasket placement on the hydrophilic membrane surface. A uniform boundary area predetermined and providing a constant thickness in the z-direction and/or a constant boundary layer caused by either selectively rendering the nylon non-porous or by selective removal of part of the nylon surface from the glass slide is the resultant of the present disclosure.

In accordance with these and further objects, one specific representative aspect of the present disclosure includes a composite device which may be useful for carrying a microarray of biological polymers, the device comprising: a microporous membrane operatively connected to a non-porous substrate having at least one predetermined shaped hydrophilic microporous membrane region, the device having a hydrophobic zone boundary surrounding the at least one predetermined shaped hydrophilic microporous membrane region, the hydrophilic porous material containing tortuous channels and pores.

In the event that two or more separate predetermined shaped hydrophilic microporous membrane regions are desired, the hydrophobic zone boundary is shaped so that the hydrophobic zone boundary separates adjacent regions of the hydrophilic microporous membrane mounted on the substrate, the hydrophilic microporous membrane containing tortuous channels and pores such that the fluid contained within one hydrophilic region does not cross the hydrophobic zone boundary into any adjacent region. One possible specific application for such innovative is a combination composite microarray slide useful in microarray applications.

Another aspect of the present disclosure includes a method of fabricating a composite device comprising the acts of: providing a non-porous substrate; providing a hydrophilic porous membrane; operatively connecting the non-porous substrate to the microporous membrane; and operatively forming at least one predetermined shaped hydrophilic porous material region having a hydrophobic zone boundary.

In the event that two or more separate predetermined shaped hydrophilic microporous membrane regions are desired, the methods of the present disclosure may be employed to operatively form multiple hydrophobic zone boundaries that separates adjacent regions of a hydrophilic porous membrane on the non-porous substrate, the hydrophilic porous membrane containing tortuous channels and pores such that the fluid contained within one hydrophilic region does not cross the hydrophobic zone boundary into any adjacent hydrophilic region.

Other objects and advantages of the disclosure will be apparent from the following description, the accompanying drawings and the appended claims.

### BRIEF DESCRIPTION OF THE DRAWINGS

FIG. 1 is a representative depiction of a representative Nylon composite slide with an ablated surface formed from hot die stamping, useful with the present disclosure;

FIGS. 2A-2C are representative depictions of the Hot Die Stamping Stages for composite slide stamping, illustrating how to precisely locate and immobilize the composite slide against predetermined reference points (pins) prior to applying the hot die stamp to the composite slide;

FIGS. 3A and 3B are a representative graphic depiction of Die heating and containment fixtures for hot die stamping that may be used to form the at least one predetermined shaped hydrophilic porous material region having the hydrophobic zone boundary that separates adjacent regions of a hydrophilic porous material mounted on the substrate of FIG. 1;

FIG. 4A is a representative graphic depiction of a prototype hot die stamping dimensions with offset, useful with the present disclosure;

FIG. 4B is a representative graphic depiction of a prototype hot die stamping dimensions without offset, useful with the present disclosure;

FIG. 5 is a representative graphic depiction of the dimension measurements for an ablated nylon substrate surface using the heat die stamp method, as discussed in Example 1;

FIG. 6 is a representative graphic depiction of the side view of a representative leak test apparatus, useful with the present disclosure;

FIG. 7 is a representative graphical depiction of the top view of the leak test apparatus of FIG. 6, useful with the present disclosure;

FIG. 8 is a representative graphical depiction of a representative knife edge ablated area definition, useful with the present disclosure; and

FIG. 9 illustrates representative laser vector lines defining at least one predetermined shaped hydrophilic porous material region having the hydrophobic zone boundary that separates adjacent regions of a hydrophilic porous material mounted on a representative microarray slide, useful with the present disclosure;

### DETAILED DESCRIPTION OF REPRESENTATIVE EMBODIMENTS

Unless indicated otherwise, the terms defined below have the following meanings:

“Analyte” or “analyte molecule” refers to a molecule, typically a biological macromolecule, such as a polynucleotide (including, but not limited to, DNA, RNA, cDNA, mRNA, PNA, LNA) or polypeptide, or peptide whose presence, amount, and/or identity is to be determined. A biological polymer may be used as an alternate term for a biological macromolecule. The analyte is one member of a ligand/anti-ligand pair. Alternatively, an analyte may be one member of a complimentary hybridization event.

“Analyte-specific assay reagent” refers to a molecule effective to bind specifically to an analyte molecule. The reagent is the opposite member of a ligand/anti-ligand binding pair.

An “array of regions on a solid support” is a linear or two-dimensional array of preferably discrete regions, each having a finite area, formed on the surface of a solid support.

A “microarray” is an array of regions having a density of discrete regions of at least about 100/cm², and preferably at least about 1000/cm². The regions in a microarray have typical dimensions, e.g., diameters, in the range of between about 10-250 μm, and are separated from other regions in the array by about the same distance.

A “phase inversion process” is meant to encompass the known art of porous membrane production techniques that involve phase inversion in its various forms, to produce “phase inversion membranes.” By “phase inversion membranes,” it is meant a porous membrane that is formed by the gelation or precipitation of a polymer membrane structure from a “phase inversion dope.” A “phase inversion dope” consists of a continuous phase of dissolved polymer in a good solvent, co-existing with a discrete phase of one or more non-solvent(s) dispersed within the continuous phase. In accordance to generally acknowledged industry practice, the formation of the polymer membrane structure generally includes the steps of casting and quenching a thin layer of the dope under controlled conditions to effect precipitation of the polymer and transition of discrete (non-solvent phase) into a continuous interconnected pore structure. In one manner of explanation, this transition from discrete phase of non-solvent (sometimes referred to as a “pore former”) into a continuum of interconnected pores is generally known as “phase inversion.” Such membranes are well known in the art. Occasionally, such membranes and processes will be called “ternary phase inversion” membranes and processes, with specific reference to the ability to describe the composition of the dope in terms of the three major components; polymer, solvent, and non-solvent(s). The presence of the three major components comprise the “ternary” system. Variations of this system include: liquid phase inversion, evaporative phase inversion, thermal phase inversion (where dissolution is achieved and sustained at elevated temperature prior to casting and quenching), and others.

The term “ablation” refers to the physical change of a part or component of a part by vaporization, crushing, collapse, melting, or other means. As one example, Nylon membrane is the part that is ablated during the performance of the process disclosed in the present disclosure. During ablation, the once porous and hydrophilic nylon membrane becomes non-porous and hydrophobic. Ablation, as used in the present application, can result in either a non-porous film, or the loss of substantially all the polymer membrane at the point of ablation.

The term “composite slides” refers to the product where membrane is adhered to a solid (typically glass) substrate with the use of a surface treatment such as a silane anchor covalently bonded to an epoxy linker attachment chemistry. This surface treatment functions as an adhesive. The epoxy adhered membrane is dried and cured to the glass substrate. Current product configuration is about 3 inches×about 2.5 inches. Such products are useful in molecular biological diagnostics as a microarray.

The term “hydrophobic zone boundary” refers to an ablated area operatively positioned on the composite slide's membrane surface defining a boundary, the boundary being defined by the ablated area, the ablated area having any one of a plurality of possible geometrical shapes.

The hydrophobic zone boundary is shaped so as to provide a footprint for applying a gasket to the membrane surface of the composite slide when the composite slide is utilized in microarray applications. The gasket and/or boundary layer interface is effective to substantially contain or prevent fluid leakage outside the ablated area defining the hydrophobic zone boundary surrounding the predetermined hydrophilic area. It should be noted, that even without the gasket, there is no leakage evident when liquid is puddled within the hydrophilic area of the microarray that is surrounded by the hydrophobic zone boundary. The fluid is contained by the hydrophobicity of the hydrophobic zone boundary and by the fluids own surface tension.

The term “hot die stamping” refers to a method of ablating nylon membrane or other porous material to provide a uniform hydrophobic zone boundary. A stamp die with a predetermined dimension is heated to temperatures near or exceeding the melt point temperature of nylon or other porous material. The heated stamp die is placed in contact with the membrane mounted on the substrate, such as, for example, laminated glass. Temperature, pressure, die contact distance, and die contact dwell time, ablates the predetermined surface of the nylon membrane in accordance with the die dimension.

The term “stamp dies” refers to stamp dies that comprise specific geometric shapes and dimensions. Stamp dies are made of materials that possess high thermal conductivity. Materials include steel, brass, copper and aluminum and other material having similar thermal properties. Stamp dies can also be comprised of multi materials, or coated with die releasing materials such as chrome plate, dicronite or Teflon®. Stamp dies have a predetermined geometric shape that is used to provide the hydrophobic zone boundary dimension. Typically, the predetermined die geometric shape that comes into contact with the membrane surface of the composite glass substrate will provide a hydrophobic zone boundary with the same predetermined geometric shape.

The term “knife edge dies” refers to dies composed of specific geometric shape and dimensions. A step or recessed area is built into the die surface to provide point or line ablation on the membrane surface of the laminated glass, utilizing conductive and/or radiative heat transfer to the membrane surface of the composite substrate. Knife edge dies are also made of materials that possess high thermal conductivity.

The term “laser” refers to a highly focused beam of synchronized single-wavelength radiation used to ablate porous material such as, for example, membrane. Table top, commercially available, air cooled, CO₂ lasers were used for ablation of the representative nylon membrane surface on the representative composite glass slides, as described in the present disclosure.

The term “vector cutting” refers to a type of laser etching. To produce laser etching on a surface, the laser is on continuously at a specified power and frequency, providing the line or point ablation of the membrane coated glass slide. Laser power, speed and frequency will dictate the degree of vector line thickness and depth of surface ablation.

The term “mastering cutting” refers to another type of laser etching. To produce rastering cutting on a surface, the laser pulses at a specified dots per inch (dpi), power and speed, providing the ablation of the membrane coated glass slide. The rastering etching method provides uniform depth ablation over a predetermined area of the representative membrane glass slide

The term “leak test” refers to a test method to determine the amount of fluid loss within the hydrophilic area encased by the hydrophobic zone boundary. An apparatus comprised of a composite test slide, a cover glass slide, and a gasket, and a clamping mechanism to apply an even pressure around the gasket is assembled and weighed. The cover glass slide is removed. A predetermined volume of fluid (typically water) is applied within the hydrophilic area encased or surrounded by the hydrophobic zone boundary, and the cover glass is placed over the gasket and clamped under constant pressure. The sample is weighed and placed in an oven at or about 55° C., at or about 18 hours. After about 18 hours at elevated temperature, the sample is weighed, and the fluid weight loss is determined. The percentage of fluid weight loss is calculated. The amount of fluid that escapes from the hydrophilic area encased or surrounded by the hydrophobic zone boundary, determines the effectiveness of the hydrophobic zone boundary to retain fluid within the hydrophilic area encased or surrounded by the hydrophobic zone boundary.

The present innovation will be illustrated via one representative specific application that being composite microarray slides which comprise a porous nylon or other polymer membrane bound to a solid backing, typically a glass microscope slide. Microarray slides are used in gene sequencing and expression analysis applications where thousands of hybridization assays are performed on the surface of a single microarray slide.

It should be understood that the utilization of composite microarray slides is not intended to represent the only possible use of the present innovation but is intended to be merely representative only and that there are a tremendous number of other useful applications for the present innovation and that all such useful applications are intended to be covered by the claims of the present disclosure.

As stated above, the problem to be solved was the failure of the Nylon membrane, which is a hydrophilic porous material, containing tortuous channels and pores for fluid flow and filtration, to provide a suitable surface for containing the liquids positioned on the membrane during certain operations necessary for microarray applications, such as, for example, sealing a membrane surface to prevent the lateral flow of a fluid outside a desired defined area, the membrane surface being less uniform in the z-direction and does not provide as suitable a surface for sealing as a flat film (example: polyester film/Mylar®).

As is known, the pore structure and hydrophilic character of nylon membrane and other known similar porous material promotes seepage of liquids in a lateral flow mode, which allows liquid to flow under a containment barrier that is normally employed during certain operations for microarray applications or other similar operations, such as, for example gaskets. Therefore, a compressed gasket on a hydrophilic nylon membrane surface does not provide a sufficient boundary to contain fluid within a predetermined area sealed by a compressed gasket. Because of the porous nylon membrane surface and porous path remaining under the compressed gasket, fluid dispensed within the gasket sealed area, will leak beyond the predetermined liquid receiving area. Providing a hydrophobic zone, a uniform boundary layer in the z-direction, or removal of the nylon porous surface having a predetermined geometric shape, under the enclosed gasket area of the nylon membrane surface is needed to prevent significant loss of a dispensed fluid within the predetermined liquid receiving area.

The following is a general description of such representative improved modified composite microarray slides, as disclosed in the Solomon et al., application, and will be conveniently described by way of the representative description contained in the Solomon et al. application. In that regard, one representative example is reproduced from the Solomon et al. application below:

First, a glass slide is selected, and cleaned, via any suitable means, as would be understood by one skilled in the art. Following cleaning, a chemical agent that performs the anchor function is applied to the glass slide, rinsed to remove any excess material or reagent, and cured, via an ambient cure, elevated temperature cure, or any combination thereof as would be understood by one skilled in the art. One suitable chemical that functions as an anchor is 3-aminopropyl triethoxysilane. After the excess material/reagent has been removed and the remainder is cured on the glass slide, a solution of a suitable chemical reagent that performs the “linker” function is prepared, as follows.

One presently preferred chemical reagent that functions as a linker for utilization with the new and improved system of the present disclosure is a Bisphenol A type epoxy, commercially known as Epon 828.

To effectuate curing, any number of curing agents may be used, but at this point, utilization of a polyamide based curing agent, particularly Epikure 3115, is presently preferred. The two components are mixed, using any suitable means, as would be understood by those skilled in the art. Finally, a suitable epoxy-functional silane may be added to the above described mixture of chemical reagents. One such, presently preferred, epoxy-functional silane is 3-glycidopropyltrimethoxysilane. Once mixed, all three of the above described chemical components are dissolved in a suitable solvent, such as, for example, xylene, for application to the glass slide. A thin layer of the epoxy mixture is then applied to the glass slide via spin coating. The nylon microporous membrane is then operatively positioned relative to the treated glass slide, restrained in the x-and-y directions, and then oven-cured, as would be understood by those skilled in the art.

In accordance with the Solomon et al., application, there are many possible variations to the disclosed chemical agents that comprise a surface treatment for providing an attachment layer between the porous membrane and the substrate that would be known to those skilled in the art including, but not limited to, modifications to the silane (anchor) moieties. Further, many alternate functional groups on the silanes may be used for reactivity with glass, including, but not limited to, amines, epoxies, and many others.

Concerning the method of application of the chemical agents on the surface treatment resulting in the attachment layer, spin-coating is only one of a plurality of possible methods of applying the surface treatment to the surface of the substrate. Other possibilities include, but are not limited to, drawdown (knife-style), spraying, coating with a slot-die, or equivalents. The presently perceived primary advantage of spin-coating is the resulting high uniformity of application of chemical agent comprising the surface treatment on the micro scale.

Concerning the membrane type, high and low amine nylon 6, 6 have been successfully tested with the chemical agents that comprise the anchors and linkers resulting in the attachment layer of the present disclosure; however, alternate membrane types, including but not limited to, alternate nylons (such as, for example, nylon 4,6) are considered to be within the scope of the present disclosure. Additionally, the use of alternate polymer types may also be feasible, as would be understood by one skilled in the art, including, but not limited to polysulfone, polyethersulfone, polyvinylidenediflouride (PVDF), and nitrocellulose.

In the practice of the Solomon et al. application, the membrane may be applied either wet or dry. Use of wet membrane is presently preferred for added bond strength and uniformity of attachment between the membrane and the substrate.

In the practice of the Solomon et al., application, the membrane may be charged or uncharged and the pore size and thickness of the membrane can be manipulated to any desired range, as would be understood by one skilled in the art. The membrane may or may not contain pigment for modification of optical surface reflectance properties.

Method for the Attachment of Nylon Membrane to a Glass Substrate: Utilizing the Chemistries and Techniques of Example 1 of the Solomon et al. Application, with a Carbon Black Pigmented Membrane

Production of Nylon/Glass Composite slides useful as a composite microarray slides for carrying a microarray of biological polymers was carried out as follows in accordance with the Solomon et al., application.

This representative Example described the process for producing a sample batch of the nylon/glass composite slides. The representative nylon/glass composite slides which were produced were comprised of a thin (˜2 mil) layer of porous nylon membrane operatively bound to the surface of a glass microscope slide. Such slides have proven operable as composite microarray slides useful for carrying a microarray of biological polymers.

The representative process was initiated by dissolving one packet of NoChromix® (Godax Labs, Inc) into about 2.5 L of concentrated sulfuric acid, then stirring thoroughly until all crystals were dissolved to produce a cleaning solution. Next, the previously prepared cleaning solution was poured into a glass dish (Thermo Shandon model 102), and allowed to sit for about 10 minutes. Glass microscope slides were placed into a 20 slide rack and then immersed in the cleaning solution, above, for about 30 minutes, then transferred to another dish filled with about 18 mΩ DI water where they remained for about 20 minutes. The slides were then dipped briefly in HPLC grade denatured ethanol (Brand-Nu #HP612) and then silanated by the procedure described below. Alternately, the slides may be cleaned with an about 1 wt % solution of Alconox in DI water; air agitated for about 30 minutes, or a heated ultrasonic bath, followed by about a 30 minute sparge with frequently refreshed baths of 18 mΩ DI water.

The slides were silanated by the following representative procedure: First, an about 100 mL solution of about 95% ethanol and about 5% water (percent by volume) was prepared. Then, about 2 mL of 3-aminopropyldimethylethoxysilane (United Chemical Technologies #A0735) was added to the above solution, mixed thoroughly, and allowed to sit for about 5 minutes. After the preceding about 5 minute activity was complete, the resulting solution was poured into glass dish, and the slides were immersed therein for about 2 minutes. The slides were then removed from the silane solution, dipped into a dish containing ethanol for about 7 seconds, and removed from the dish. The slides were then placed into an oven for about 10 minutes at about 110° C., and allowed to finish reacting overnight.

The next day, a representative Bisphenol A “linker” solution was made by adding the following to a 250 mL Erlenmeyer flask and mixing thoroughly after each step in which a new ingredient was added:

about 10 grams Epon 828 (a Bisphenol A type epoxy resin); and

about 34 grams Xylene.

In a separate 250 mL Erlenmeyer flask, the following were also added:

about 4.1 grams Epikure 3115 (a polyamide based curing agent);

about 34 grams Xylene; and

about 1.8 grams 3-glycidopropyltrimethoxysilane.

The contents of the first flask (epoxy) were then poured into the second flask, sealed, and agitated with a lab stirrer for about an additional about 15 hrs at about 60° C. The resultant solution from the combination of the two flasks described above resulted in an about 12 wt % Bisphenol A “linker” solution.

Following the mixing cycle, a single cleaned and silanated slide was then placed on a spin coater (Specialty Coating Systems model P6708). Surface was flooded with the epoxy solution prepared above, then allowed to spin at the following cycle:

| RPM | Time (seconds) |
|---|---|
| ˜500 | ˜10 |
| ˜900 | ˜10 |
| ˜3000 | ˜20 |

Next, the slides were removed from the spin coater, and placed on a 5 inch×10 inch metal plate. Next, wet-as-cast porous nylon membrane (as described in U.S. Pat. Nos. 3,876,738 and 4,707,265), which had additional pigment added to modify the optical reflectance properties, of the membrane (as described in commonly owned U.S. Pat. No. 6,734,012 was operatively positioned over the slides then stretched flat and clipped into position. Personnel wearing gloves handled the wet-as-cast porous nylon membrane. The wet-as-cast porous nylon membrane used had been cast, quenched, and washed with DI water, but had not yet been exposed to a drying step, hence the term “wet-as-cast.” The wet-as-cast porous nylon membrane had a thickness of approximately 1.5 mils, a nominal pore size less than about 0.2 micron, and a target initial bubble point in water of about 135 PSI (once dried). The base polymer for this wet-as-cast porous nylon membrane is Vydyne 66Z nylon (Solutia, Inc), which is a high molecular weight nylon that is preferentially terminated by amine end groups.

During the application of the wet-as-cast porous nylon membrane to the treated slides, care was taken to ensure removal of any air bubbles between the wet-as-cast porous nylon membrane and each slide. The wet-as-cast porous nylon membrane was flattened onto each slide and all wrinkles were removed.

Once positioned on the slides, the wet-as-cast porous nylon membrane was clipped into position, as is known in the art. The entire assembly was then heated in a convection oven at about 110° C. for about 45 minutes. After heating, the excess, now dried, porous nylon membrane was removed from the slides by trimming, as is known in the art.

Following trimming, the slides were allowed to sit overnight, in order for the epoxy resin to further cure. To test the adhesive strength of the membrane to the substrate by the attachment layer produced utilizing the above process, a solution of 4×SSC (sodium salt, sodium citrate) was prepared by diluting a stock 20× solution (Sigma # S6639).

The slides were placed into a Tupperware container, SSC solution was poured on top of the slides, and the container was sealed. The container was then placed in a hybridization oven at about 60° C. for a minimum of about 12 hours with gentle rocking.

Upon removal from the solution, all the membrane components of the composite slides were found to be securely bonded to the substrate component, with no delamination of the membrane from the substrate. The slides that were exposed for a longer period at 60° C., in excess of 72 hours, also showed no delamination of the nylon from the substrate.

Further testing of adhesion between the membrane and the substrate was accomplished by the following method: first, two (2) slides were selected and placed in a 60 mL vial. Next, a solution of n-dimethylformamide (DMF, Aldrich 31,993-7) was poured over slides, and the lid sealed. DMF is an aggressive solvent that can be used to apply a variety of chemistries to the surface of slides, and is known to attack common adhesives such as acrylates, urethanes, and polyesters. The slides were allowed to sit at room temperature for a minimum of about 6 hours, then removed and rubbed firmly.

After the above treatment, the slides exhibited no loss of adhesive strength of the bond between the membrane and the substrate after immersion in DMF, even after exposure at room temperature for about 2 weeks.

Unless otherwise indicated, all numbers expressing quantities of ingredients, properties such as molecular weight, reaction conditions, and so forth used in the following are to be understood as being modified in all instances by the term “about.” Accordingly, unless indicated to the contrary, the numerical parameters set forth in the following claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

After the improved composite microarray slides useful for carrying a microarray of biological polymers on the surface thereof and, more particularly, to an improved composite microarray slide having a porous membrane formed by a phase inversion process effectively attached by covalent bonding or hydrogen bonding through chemical agents that comprise a surface treatment to a substrate, the surface treatment preparing the substrate to sufficiently bond to the microporous membrane through the attachment layer formed therebetween resulting from the surface treatment such that the combination produced thereby is useful in microarray applications was completed, the need to develop methods for effectively containing microarray fluid chemistry within a predetermined hydrophilic region or zone on the membrane surface of the improved composite microarray slides, such as, for example, a nylon coated, composite microarray slide was soon recognized.

Creating a hydrophobic zone on the hydrophilic porous material surface of the composite microarray slide which, allows fluid to be contained within the predetermined hydrophilic area, and provides a uniform surface for a gasket sealing o-ring to be operatively positioned relative thereto appeared to be a possible solution to the microarray fluid chemistry containing problem on the improved composite microarray slides. As is known, nylon membrane is a hydrophilic porous material, containing tortuous channels and pores for fluid flow and filtration.

The following methods have been determined to be effective to establish and control hydrophobic boundary geometries on a representative nylon composite microarray slide, thus preventing liquid from leaking from the predetermined hydrophilic area of the composite microarray slide across the hydrophobic boundary to other predetermined hydrophilic area of the composite microarray slide, if any. It is believed that the processes and methods herein described can be used for alternate porous polymers attached to a solid substrate, where hydrophobic areas need to be created for liquid containment on the hydrophilic porous supported surface.

One such process for obtaining a hydrophobic, ablated area on a porous composite substrate, involves the use of a hot die stamping process. The hot die stamping process is accomplished by placing a heated die having a predetermined geometric shape unto the porous polymeric surface such as, for example, nylon surface of the composite microarray slide for a specified dwell time. Once positioned, the die is heated to a temperature at or near the melt point temperature of the nylon polymer membrane. The nylon polymer membrane surface then vaporizes or melts, leaving a hydrophobic boundary zone having a predetermined geometric shape that surrounds at least one hydrophilic zone on the surface of the composite slide, the predetermined geometric shape of the hydrophilic zone being defined by the shape and dimensions of the die used in the stamping process. The hydrophobic boundary zone geometric shape is consistent with the die geometric shape and surface area that comes in contact with the nylon polymer membrane on the surface of the composite slide. The hydrophobic zone created thereby will not allow fluids to flow into, out of or around a fluid hydrophilic containment area defined by the die geometric shape. The surface of the thus formed hydrophobic zone is much flatter than the contiguous hydrophilic porous nylon surface, thus allowing a device, such as, for example, a gasket to be operatively positioned within the predetermined hydrophobic zone to effectively create a hydrophobic boundary zone surrounding the hydrophilic portion of the porous composite substrate.

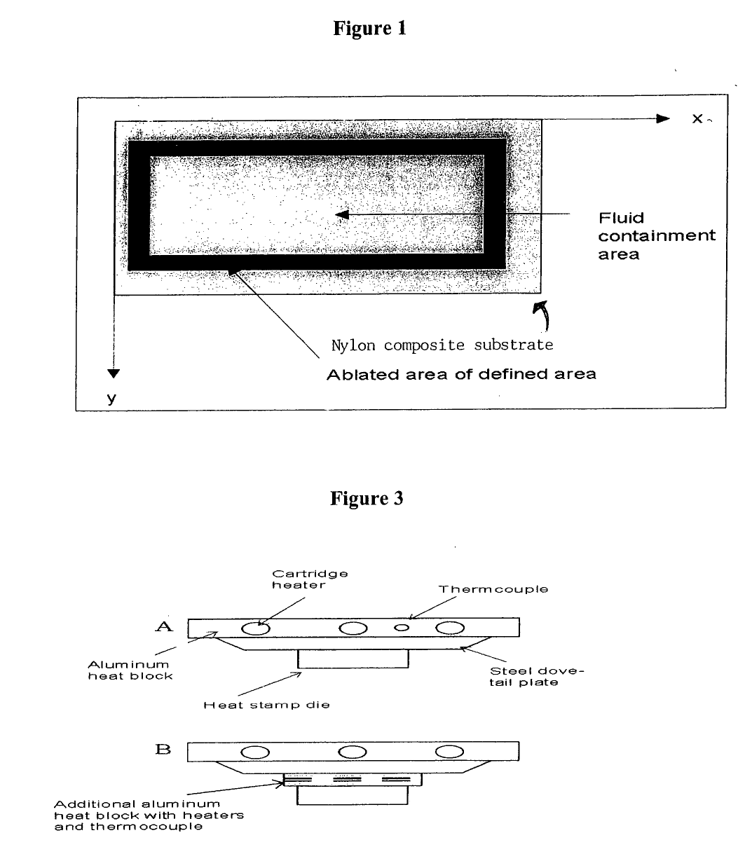

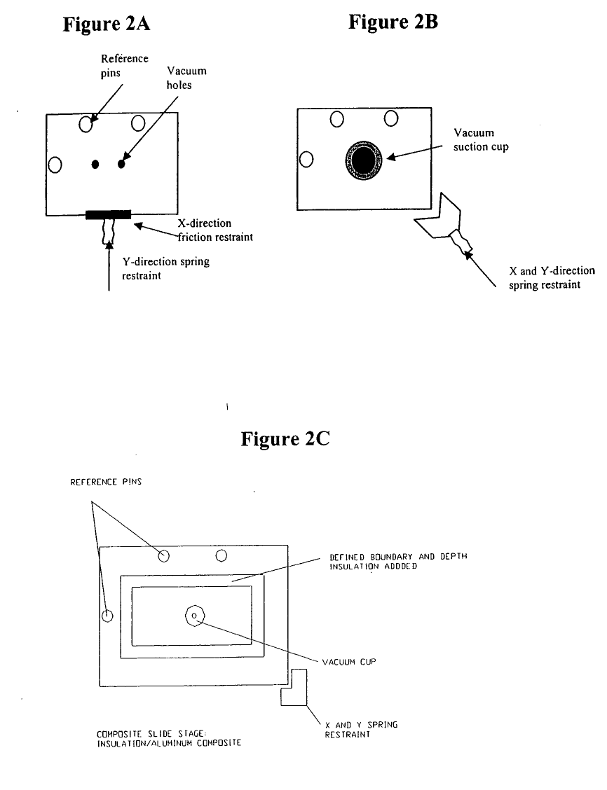

FIG. 1 illustrates a representative composite microarray slide produced using a representative hot die stamping process comprises positioning a heated die in a fixed position in the x and y axis above the porous composite substrate which is precisely located and immobilized or restrained in a suitable fixture (see FIGS. 2A-2C). The representative composite microarray slide is restrained by the fixture positioned below the die (see FIG. 2). The representative composite microarray slide is restrained in the x and the y plane, and is referenced in the same position at the start of each stamping. The representative composite microarray slide is restrained in order to maintain dimension boundaries for die placement on the representative composite microarray slide. The representative composite microarray slide is restrained by conventional means, such as, for example, vacuum, tension springs, and/or reference pins etc.

As shown in FIGS. 2A-2C, upon restraining the representative composite microarray slide, a hot die will traverse along the z axis until the die comes in contact with the upper surface of the representative composite microarray slide. As shown, a positive stop may be used to prevent the die from crushing the porous composite substrate, and maintain a predetermined placement in the z-direction. The dies that are utilized in the representative process have a predetermined shape for surrounding a predetermined surface area of the composite microarray slide to be isolated. The dies and die fixture are heated to a predetermined temperature at or near the melting point of the porous material attached to the non porous substrate. Temperature control of the die can be maintained within about 1° Fahrenheit.

FIGS. 2A, 2B and 2C are diagrams of the production stages for providing a consistent positioning of the representative composite microarray slide that are used in the hot die stamping process. The various production stages are used to position the representative composite microarray slide along the x and y axis.

As illustrated in FIG. 2A, reference pins position the representative composite microarray slide on the x-axis. A clip spring applies pressure along the axis to maintain constant pressure during hot die stamping. Vacuum holes are operatively position thereon for cooperating with a vacuum suction cup, as illustrated in FIG. 2B.

As illustrated in FIG. 2B, a vacuum is applied to the center of the bottom of the representative composite microarray slide to maintain position of the representative composite microarray slide during hot die stamping. The reference pins are used to keep the representative composite microarray slide stationary. In addition, the clip spring is positioned in the corner to keep constant pressure along the x and y axis during stamping, thus maintaining position of the glass slide during the ablation process.)

As illustrated in FIG. 2C, in addition to the spring clip and vacuum suction cup for the representative composite microarray slide staging, insulation is added during this stage. The insulation is consistent to the hot die stamping. The heat insulation includes, but is not limited to, ceramic, layered composite, such as mica, or high heat resistance material. This heat insulation keeps the temperature in the insulated area, focused on the representative composite microarray slide ablation area

Upon restraining the representative composite microarray slide, a hot die will traverse along the z axis until the die comes in contact with the upper surface, the surface having the porous material, of the representative composite microarray slide. A positive stop will prevent the die from crushing the representative composite microarray slide, and maintain a predetermined placement in the z-direction. The dies utilized in this operation have a predetermined shape and size. The dies and die fixture are heated to a predetermined desired temperature at or near the melting point of the porous material on the upper surface of the representative composite microarray slide. The die temperature control was maintained within about 1° Fahrenheit.

Typical die placements in a heating fixture are illustrated in FIG. 3. FIG. 3 shows die staging and heating of the representative dies used to effectuate the ablation of the upper surface of the representative composite microarray slide. As is known in the art, the dies are secured in a dovetail steel plate or similar fixture. The fixture is heated by adding electrical heating cartridges. Because the die is in direct contact with the heating block, temperature uniformity within the die is approximately consistent.

The illustrated dies are made according to predetermined shapes in order to form the hydrophobic zone boundary that separates adjacent regions of a hydrophilic porous material mounted on representative composite microarray slides. The dies are presently preferably made of highly conductive materials, including, but not limited to, brass, copper, steel, aluminum and chrome etc. However, it is understood that any material that can maintain temperatures or transfer heat, at or near the melting point of the porous material that comprises the upper surface of the representative composite microarray slide can be utilized.

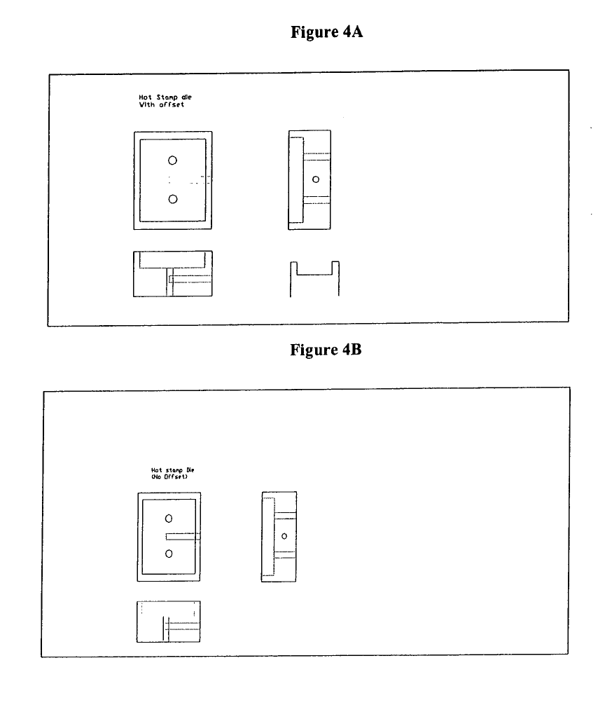

Typical hot dies used in ablation of porous substrates are illustrated in FIGS. 4 and 4B. Dies can have flat surface of have a contact surface that provides an offset. Offset dies will provide degrees of ablation on the composite surface. The knife edge (offset die), will make contact with the upper surface of the representative composite microarray. This allows the knife edge to provide complete ablation along the knife edge axis. As shown, representative stamping dies are illustrated having representative detailed dimensions and sizes for a representative die used for porous material ablation.

As illustrated, the hot die stamping ablates the surface of the porous nylon membrane, leaving a predetermined geometrically shaped impression, upon retraction of the stamp die. The die dimensions are correlated to a specifically desired finished ablated porous material shaped surface designed to surround the desired predetermined hydrophilic porous material mounted on a substrate, the impression defining a hydrophobic zone boundary. The hydrophobic zone boundary dimension measurements can be measured using an optical comparator, or computer optical scanner.

FIG. 5 illustrates a representative composite microarray slide with an ablated surface that was formed using hot die stamping. The white area represents where the hot die came in contact with the porous material that forms the upper surface of the representative composite microarray. As would be clear to one skilled in the art, the dimension of the hot die can be changed, based on die contact surface dimension, contact time and temperature of the die surface and other appropriate factors in order to define the hydrophobic zone boundary that surrounds the shaped surface designed to surround the desired predetermined hydrophilic porous material mounted on a substrate.

As shown, the white surface represents the ablated hydrophobic zone boundary area of the porous surface on the total representative composite microarray slide area. The grey area represents the desired predetermined hydrophilic microporous surface not ablated on the total upper surface of the representative composite microarray slide. The white surface area shows the dimension measurements for the ablated porous material surface wherein the grey surface represents the unablated area of the upper surface of the representative composite microarray slide.

As would be known to those skilled in the art, the various dimensions of the illustrated composite microarray slide can be manipulated such that the various measurements can determine the hydrophobic zone boundary placement, inside hydrophobic zone boundary dimensions, and thickness of the ablated area. The white surface area indicates the ablated hydrophobic zone boundary area of the porous surface on the total representative composite microarray slide surface area.

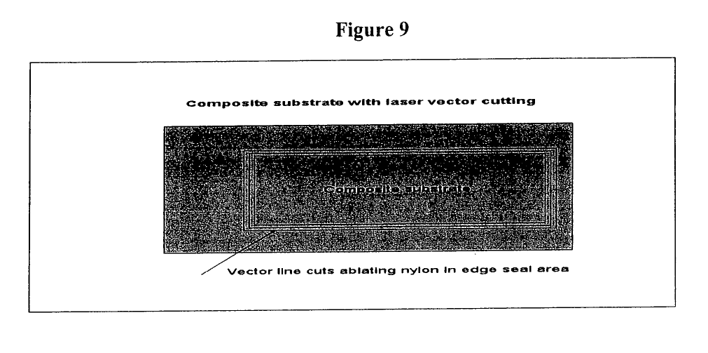

A knife edge heat stamp product is illustrated in FIG. 8. As shown in FIG. 8, the grey area indicates the porous material surface not ablated on the total composite microarray slide area, the white portion represents the ablated area wherein at least a portion of the remaining porous material remains positioned on the non porous substrate and the black lines in and around the surface of the ablated hydrophobic zone boundary representative areas that are completely ablated/removed from the surface of the porous material and form line channels on the representative composite microarray slide.

### EXAMPLE 1

### Control Slide

A control sample was conducted along with the test slide samples. The control sample consisted of two glass slides containing the gasket and test fluid only. The control sample was tested and compared with the representative porous composite microarray slide having ablated hydrophobic area boundary.

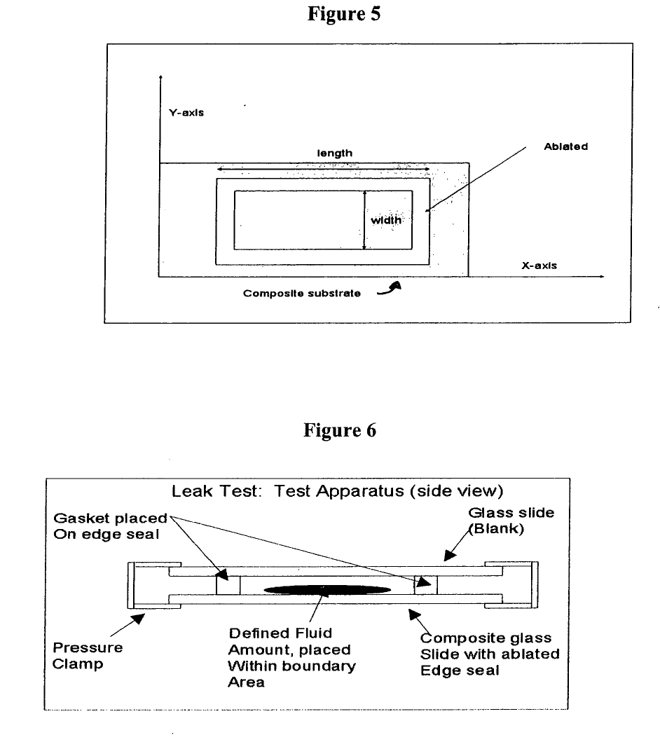

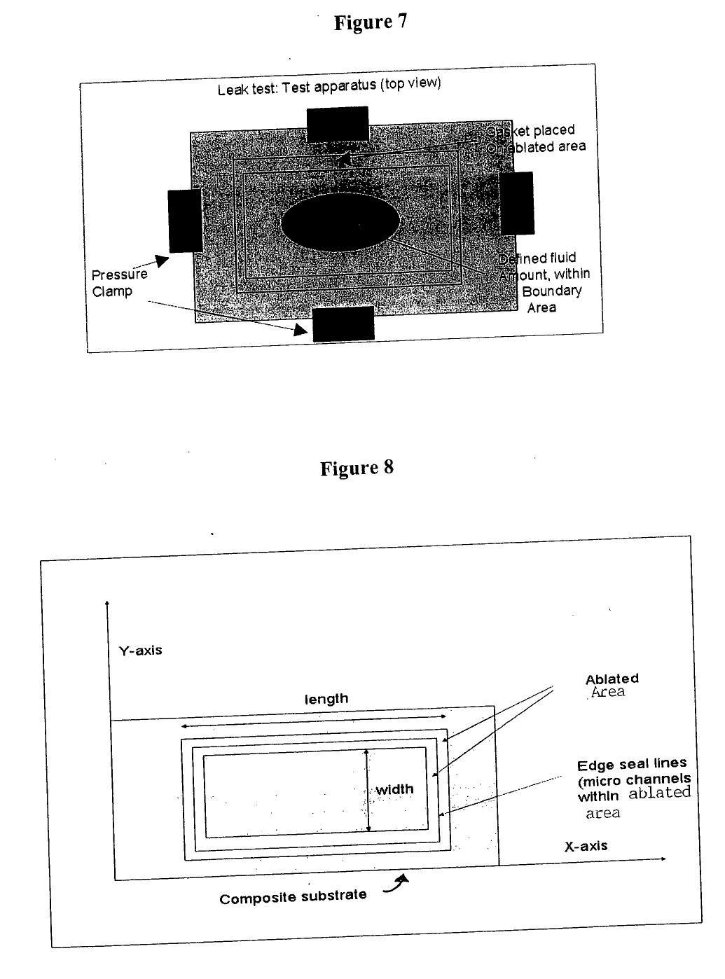

The control sample determined if the gasket and test apparatus is able to contain the fluid. The control samples established a functional baseline; i.e. fluid leakage for the gasket only. FIGS. 6 and 7 illustrate the test apparatus used to conduct the leak tests.

A control slide is a plain glass slide with no membrane attached. The intention of the control slide is to function as control in the leak test. The control slide is not porous and has no hydrophilic zone, therefore, it should provide a baseline for the leak test.

TABLE 1
Control slide percent fluid loss for a leak test

| | | Initial | Final Mass | |
|---|---|---|---|---|
| | | Mass Gasket | Gasket | |
| | | Assembly + | Assembly + | |
| | Mass Gasket | 1 mL | 1 mL | |
| Slide # | Assembly (g) | H2O (g) | H2O (g) | % leakage |
| CONTROL | 61.875 | 62.916 | 62.889 | 2.59 |
| SLIDES | | | | |
| CONTROL | 62.083 | 63.067 | 63.04 | 2.74 |
| SLIDES | | | | |
| CONTROL | 61.133 | 62.709 | 62.682 | 1.71 |
| SLIDES | | | | |
| Average | 61.70 | 62.90 | 62.87 | 2.35 |
| Standard | 0.499 | 0.180 | 0.180 | 0.556 |
| Deviation | | | | |

### EXAMPLE 2

### Composite Slide with No Ablation

This is the composite slide described in Solomon, et al. which has a microporous membrane attached to a glass substrate, but has no ablated areas. The intention of the composite slide is to demonstrate the problem of leakage in a microarray application where a gasket is applied as a sole means of fluid retention in the hydrophilic zone.

Upon repeated leak testing, it was discovered that the non ablated substrate membrane was bone dry, after removal of the leak test assembly. It is therefore concluded that all the water (100%) was evaporated and lost from the test apparatus

TABLE 2
Non ablated composite slide leak test data

| | | Initial | Final | |
|---|---|---|---|---|
| | | Mass Gasket | Mass Gasket | |
| Standard | | Assembly + | Assembly + | |
| slides (non | Mass Gasket | 1 mL | 1 mL | |
| ablated) | Assembly (g) | H2O (g) | H2O (g) | % leakage |
| 1 | 62.76 | 63.82 | 62.74 | 101.9 |
| 2 | 62.84 | 63.87 | 62.87 | 97.1 |
| 3 | 63.1 | 64.08 | 63.08 | 102 |

The variation in % leakage noted above is believed to be representative of the error in the gravimetric measurements used in the present leak test.

In the application of the hot die stamping process, the dies are heated at or near the melt point temperature of the polymer surface for effective ablation and creation of the predetermined hydrophobic zones. The typical operating temperatures for dies used to stamp nylon covered representative composite microarray slides are from about 600 to about 850° Fahrenheit. During the process, the dies will expand as die surface temperature increases. This thermal expansion is dependent on the particular type of die material. As would be expected, the die expansion is in the x and y axis and is typically uniform across the surface of the die.

Hot die ablation of a representative porous composite microarray slide can be made in any one of a plurality of dimensions; thus defining a hydrophobic boundary around a hydrophilic composite porous membrane zone. The ablated area is defined by the die dimension, and placement on the representative porous composite microarray slide surface. Placement of the ablated area on the representative porous composite microarray slide surface is defined by the die process staging and the representative porous composite microarray slide surface area. Once the hydrophobic boundary around a hydrophilic porous material zone has been accomplished, it is believed necessary to measure the fluid loss functionality from the hydrophilic porous material zone across the representative porous composite microarray slide ablated hydrophobic boundary.

One simple and effective method for determining the ablated hydrophobic boundary capability for limiting fluid loss outside the hydrophobic boundary zone comprises applying a fluid within the hydrophilic zone surrounded by the ablated hydrophobic boundary area, which will provide fluid retention up to the point where the mass of water exceeds the microporous membrane capacity to contain the fluid, would be understood by those skilled in the art.

Another method for determining the ablated hydrophobic boundary capability for limiting fluid loss from the surrounded hydrophilic zone outside the hydrophobic zone includes performing a gasket leak test. The gasket leak test is initiated by placing a predetermined amount of fluid, typically water, within the predetermined hydrophilic porous material zone surrounded by hydrophobic boundary as zone defined by the area where the porous material was ablated. A gasket is placed on the surface of the ablated zone of the representative porous composite microarray slide and then sealed with a glass substrate on the top side, under constant compression. The gasketted representative porous composite microarray slide having the ablated porous material boundary surrounding the containment fluid is heated to about 55° C. for a predetermined time increment.

In order to calculate fluid loss, the weight of the gasket seal test apparatus is measured prior to fluid being added to the containment area, then with fluid containment prior to heating, and finally with whatever contained fluid remains after heating. The weight differences between the gasket seal test apparatus at these times determines the amount of fluid that escapes/evaporates during the test. The mass of water that is lost during heating is an indicator of the effectiveness of the ablated, hydrophobic area boundary with respect to preventing the loss of fluid from the predetermined hydrophilic zone of a sample.

Gasket are generally difficult to manufacture especially flat gaskets and can have substantial variation in both the cutting of the gasket to achieve a particular size and also in the placement of the gasket on the surface of a representative composite microarray slide. The combination of gasket placement error and gasket manufacturing error can be typically as high as about +/−0.020 in. Thus by having placed the isolated areas precisely on the surface of the representative composite microarray slide, we assist the end user to achieve the precision necessary in their application.

### EXAMPLE 3

### Hot Die Stamping with a Flat Surface Die

Hot die stamping of a nylon composite slide is achieved by using a rectangle steel die as described in FIG. 4b heated at or around 790° F. and having a contact time of around 5 seconds on the composite nylon slide surface (same composite slide construction as example 2; with the exception that the hot die creates an ablated hydrophobic rectangle with defined geometry).

In the hot die stamping process, the dies are heated at or near the melt point temperature of the porous polymer surface for effective ablation, loss of pore structure, and creation of the predetermined hydrophobic zones. The typical operating temperatures for dies used to stamp nylon micro-array slides are from about 600 to about 850° Fahrenheit. During the process, the dies will expand as die surface temperature increases. This thermal expansion is dependent on the particular type of die material. As would be expected, the die expansion is in the x and y axis and is typically uniform across the surface of the die.

Hot die ablation of a porous composite substrate can be made in any one of a plurality of dimensions; thus defining a hydrophobic boundary around a hydrophilic composite porous membrane zone. The ablated area is defined by the die dimension, and placement on the composite porous substrate surface. Placement of the ablated area on the composite surface is defined by the die process staging and composite surface area. Once the hydrophobic boundary around a hydrophilic composite porous membrane zone has been accomplished, it is believed necessary to measure the fluid loss functionality for the hydrophobic zone across the microarray slide ablated boundary.

A method for determining the ablated membrane area capability for limiting fluid loss from the surrounded hydrophilic zone outside the hydrophobic zone includes performing a gasket leak test. The gasket leak test has been described previously. FIGS. 6 and 7 illustrate the test apparatus used for the leak test.

TABLE #3
leak test data for example 3

| | | Initial Mass | Final Mass | |
|---|---|---|---|---|
| | | Gasket | Gasket | |
| | | Assembly + | Assembly + | |
| | Mass Gasket | 1 mL | 1 mL | |
| Slide # | Assembly (g) | H2O (g) | H2O (g) | % leakage |
| 1 | 62.324 | 63.323 | 63.294 | 2.9 |
| 2 | 61.922 | 62.988 | 62.959 | 2.72 |
| 3 | 61.702 | 62.697 | 62.664 | 3.32 |
| 4 | 62.071 | 62.942 | 62.913 | 3.33 |
| 5 | 62.888 | 63.88 | 63.847 | 3.33 |
| 6 | 62.545 | 63.576 | 63.549 | 2.62 |
| 7 | 62.443 | 63.468 | 63.441 | 2.63 |
| 8 | 61.636 | 62.682 | 62.649 | 3.15 |
| 9 | 62.856 | 63.878 | 63.843 | 3.42 |
| 10 | 62.354 | 63.37 | 63.342 | 2.76 |
| 11 | 62.154 | 63.19 | 63.155 | 3.38 |
| 12 | 62.102 | 63.12 | 63.086 | 3.34 |
| 13 | 62.693 | 63.697 | 63.669 | 2.79 |
| 14 | 61.266 | 62.291 | 62.262 | 2.83 |
| 15 | 62.112 | 63.175 | 63.145 | 2.82 |
| 16 | 62.533 | 63.552 | 63.522 | 2.94 |
| Average | 62.23 | 63.24 | 63.21 | 3.02 |
| Standard | 0.448 | 0.447 | 0.447 | 0.296 |
| Deviation | | | | |

Leak testing results are considered acceptable if the tested ablated slide percent leakage is less than about 10%, and control slides do not exhibit failure. The about 10% fluid loss is based on acceptance of microarray test fluid loss limits.

Measurements were made to determine the precision of both the placement and the internal dimensions of the hydrophobic ablated zone. This was done to ensure that the desired defined geometry was successfully produced on the composite slide. The measurements are taken by using an optical comparator or a camera optical measurement device.

To verify the hydrophobic zone placement on the composite slide, a series of measurements was conducted from the reference edges of the composite slide (refer to FIG. 1). Measurements were made from the x-axis and y-axis to the respective parallel boundaries of the hydrophobic ablated zone. Two measurement locations were chosen for the x-axis placement and two for the y-axis placement. A total of 17 slides were measured in each of the four reference locations. A mean and standard deviation were calculated for each of the four reference locations. The worse case standard deviation was chosen to represent the maximum offset variation relative to the reference edges.

To verify the hydrophilic zone dimensional area on the composite slide, a series of measurements was conducted from the inner edges of the hydrophobic zone (fluid containment area, refer to FIG. 1). Measurements were made of the length and the width of the fluid containment area. Two measurement locations were chosen for the length and two for the width. A total of 17 slides were measured in each of the four reference locations. A mean and standard deviation were calculated for each of the four reference locations. The worse case standard deviation was chosen to represent the maximum dimensional area variation of the fluid containment area.

As can be seen from the above Table 3, the average control slides only had about a 2.35% leakage rate, as would be expected, as this was merely a test to determine the operability of the gasket used in the test. Test results for composite microarray slides not having their upper surfaces altered in accordance with the innovations of the present disclosure indicated and almost total loss of fluid, as was also expected.

However, test results for the composite microarray slides having their surfaces altered in accordance with the above example 3 allowed only a two-three percent loss of fluid. This is believed to be significant in that is somewhat less than the 10 percent loss considered acceptable.

### EXAMPLE 4

### Knife Edge Dies for Conducting Surface Ablation and Hydrophobic Zone Boundary Definition

Knife edge dies can be used to define the ablated hydrophobic zone boundary on the representative porous composite microarray slide. Knife edge dies have a recessed area on the contact surface of the die. This recess allows for different degrees of ablation of the nylon surface of the representative porous composite microarray slide. Total porous material surface ablation is accomplished by the die areas that first directly contact the nylon surface, while the recessed die area, in close proximity to the nylon surface, accomplishes partial ablation of the nylon surface (refer to FIG. 4A). The areas between the knife edges of the recessed die provide thermal energy to at least partially ablate the porous nylon surface, i.e. some remnants of the porous nylon remains permanently connected to the nonporous substrate but little if any fluid can flow through the partially ablated area. The inside surface of the recessed die, provides a very uniform ablation, thus providing a substantially uniform hydrophobic zone boundary for gasket placement. Areas of the die (non recessed areas) that first come in direct contact with the porous nylon surface, comprise relatively thin lines, or points, which typically ablate the total surface of the porous nylon surface that they contact, thus creating channels or grooves in the non porous substrate underlying the nylon porous membrane surface. These channels act as barriers to the fluid contained within the hydrophobic zone boundary area (microarray array) surrounding the predetermined hydrophilic zone of the representative porous composite microarray slide, and does not allow fluid loss during leak testing. Recessed dies used as described above can be made of aluminum, brass, copper, or other highly thermal conductive material. The process for recessed ablation is substantially the same as described for hot die stamping. For the present Example 4, a bass die was chosen, along with a copper stage. The brass die was fabricated with 0.003″ recess. The copper stage was fabricated with recessed insulation built into the stage (refer to FIG. 4A).

TABLE 4
Leak testing for a recessed Brass die with a recessed
insulated Copper stage

| | Mass | Initial Mass | Final Mass | |
|---|---|---|---|---|
| | Gasket | Gasket | Gasket | |
| | Assembly | Assembly + 1 mL | Assembly + 1 mL | |
| Slide # | (g) | H2O (g) | H2O (g) | % leakage |
| 1 | 61.7 | 62.7 | 62.7 | 3.0 |
| 2 | 62.6 | 63.6 | 63.5 | 2.8 |
| 3 | 62.5 | 63.5 | 63.5 | 3.4 |
| 4 | 62.1 | 63.0 | 63.0 | 3.4 |
| 5 | 61.9 | 63.0 | 62.9 | 3.0 |
| 6 | 61.8 | 62.8 | 62.8 | 3.0 |
| 7 | 62.9 | 63.9 | 63.9 | 3.2 |
| 8 | 61.6 | 62.5 | 62.5 | 3.2 |
| 9 | 62.8 | 63.8 | 63.8 | 3.6 |
| 10 | 61.4 | 62.5 | 62.4 | 3.0 |
| Average | 62.1 | 63.1 | 63.1 | 3.1 |
| Std | 0.519 | 0.532 | 0.531 | 0.184 |
| deviation | | | | |

Measurements were made to determine the precision of both the placement and the internal dimensions of the hydrophobic ablated zone. This was done to ensure that the desired defined geometry was successfully produced on the composite slide. The measurement methods are described in Example 3.

As can be seen from the above Table 4, the average control slides only had about a 3.0% leakage rate, as would be expected, as this was merely a test to determine the operability of the gasket used in the test. However, the test results for the composite microarray slides having their surfaces altered in accordance with the above example 4 allow only an about three to four percent loss of fluid. This is also believed to be significant in that the loss is somewhat less than the 10 percent loss considered acceptable.

### Ablation of Porous Polymer Surface Using Laser

Single-wavelength radiation Laser light can also be used to completely ablate or partially ablate the porous material surface on the composite slide. Table top, commercially available, air cooled, 35 watt CO₂ lasers can be used for the ablation of the nylon membrane surface on the representative porous composite microarray slide. The laser can replicate the effect of hot die stamping with a rastering laser cutting, or ablate the entire nylon surface on the representative porous composite microarray slide with vector cutting. Vector cutting is a type of laser etching as specified by the commercially available laser unit. Vector laser etching is defined as the laser synchronized light source emitting continuously on at a specified power and frequency, providing the line or point substantially complete ablation of the nylon membrane covered representative porous composite microarray slide. Laser power, speed and frequency will dictate the vector line thickness dimension and the depth of ablation of the nylon porous material surface on the composite slide. The higher the laser source frequency and power, an increase in thickness of the ablation lines placed on the representative porous composite microarray slide.

Another type of laser etching is rastering cutting. When using rastering cutting, laser light pulses at a specified dot per inch (DPI). DPI, power and speed, provide the energy to ablate the porous nylon membrane surface of the representative porous composite microarray slide. The rastering etching methods provides uniform depth ablation over the predetermined area of the representative porous composite microarray slide, similar to that achieved by the previously described hot die stamping. Computer graphing software has been used to determine placement of the vector or rastering cutting on the porous material surface on the representative porous composite microarray slide, and is the laser instrument method for defining placement of the ablated boundary zone in the x and y direction.

Laser vector ablation allows lines to be cut into the porous material surface on the representative porous composite microarray slide as well as to and into the nonporous substrate. The vector line can be cut to the surface of the support substrate, thus completely ablating the nylon at the point of contact of the laser beam. The lines in the porous material and the support substrate act as barrier walls or channels to retain fluid within the predetermined hydrophilic zone surrounded by the hydrophobic zone boundary of the representative porous composite microarray slide. During use, typically, a gasket is placed over the vector cut ablated lines for testing in the leak test.

Vector cut ablation lines formed by laser vector cutting can range from one two to as many as seven or as many as may be required for a specific application within a defined hydrophobic zone boundary to provide the necessary boundary for fluid containment.

During normal application use, typically, a gasket is placed over the vector cut ablated lines for sealing the circumference of the hydrophilic zone surrounded by the hydrophobic zone boundary. FIG. 9 is a schematic illustrating ablated vector lines placed on a representative porous composite microarray slide using such lasers.

### EXAMPLE 5A, 5B AND 5C

### Surface Ablation Using Laser Vector Line Cutting

Laser cutting samples generated by the Epilog© laser were evaluated for dimensional tolerances. Vector cutting was conducted under the following Epilog© laser process settings:

TABLE 5
Vector etching laser process settings

| Rectangle Vector Cutting Laser | |
|---|---|
| Process Conditions | |
| Power (%) | 15% |
| Speed (%) | 100% |
| Frequency (Hz) | 5000 |
| Datum height (in) | 0 |

NOTE:
Cut depth is down to glass substrate.

TABLE 6
Leak testing results of laser vector cut samples of various line
configurations with comparison to Hot die stamping

| | | Average | |
|---|---|---|---|
| | | leakage | Standard |
| Example | Gasket Test | (%) | deviation |
| 5A | 1 line rectangle | 23.55 | 17.3 |
| | vector Cut | | |
| 5B | 3 line rectangle | 4.59 | 0.47 |
| | vector | | |
| | Cut | | |
| 5C | 6 line rectangle | 3.48 | 0.34 |
| | vector Cut | | |

Measurements were made to determine the precision of both the placement and the internal dimensions of the innermost hydrophobic ablated zone of the vector cut samples. This was done to ensure that the desired defined geometry was produced on the composite slide. The measurement methods are described in Example 3.

As can be seen from the above Table 6, the test results for the composite microarray slides having their surfaces altered in accordance with the above examples allow any where from an about 24% average leakage for a single line formed by laser vector cut to about a 3.5% average leakage for six (6) lines formed by laser vector cut. This is also believed to be significant in that the fluid loss for the three (3) and six (6) line results is somewhat less than the 10 percent loss considered acceptable. Further, the about 24% leakage is still abut 75% better than the substantially 100% loss for the slides that were not processed in accordance with the present innovation.

### EXAMPLE 6

### Surface Ablation Using Laser Rastering Etching

Laser cutting samples generated by the Epilog® laser were evaluated for dimensional tolerances. Rastering cutting was conducted under the following Epilog® laser process settings shown in Table 7 below:

TABLE 7
Rastering etching laser process settings

| Rectangle Vector Cutting | |
|---|---|
| Laser Process Conditions | Settings |
| Power (%) | 100 |
| Speed (%) | 17 |
| Dots per inch (Hz) | 200 |
| Datum height (in) | 1.0 |

TABLE 8
Rastering samples leak test results

| | Average leakage | Standard |
|---|---|---|
| Gasket Test | (%) | deviation |
| Raster cut slides | 9.57 | 12.8 |

Measurements were made to determine the precision of both the placement and the internal dimensions of the raster cut hydrophobic ablated zone. This was done to ensure that the desired defined geometry was produced on the composite slide. The measurement methods are described in Example 3.

As can be seen from the above Table 8, the test results for the composite microarray slides having their surfaces altered in accordance with the above example allow about a 9.6% average leakage for a laser raster cut slide. This is also believed to be significant in that the fluid loss of about 9.6% is less than the 10 percent loss considered acceptable.

While the shapes of the hydrophilic zones illustrated herein have been square or rectangular in shape, it should be understood that the innovations described herein are not limited to any specific shape and that all possible geometric shapes are believed possible in the practice of these innovations.

### EXAMPLE 7

### Surface Ablation Using Laser Rastering Etching and Vector Cutting

Laser cutting samples generated by the Epilog® laser were evaluated for dimensional tolerances. Ablation of the microarray surface was done with rastering etching and vector cutting. The hydrophobic ablated zone was first etched with a laser using rastering etching. Vector cutting with the laser defined the hydrophic ablation zone. In some samples, multiple vector lines were placed within the ablated hydrophic zone.

Raster cutting alone to ablate and form the hydrophobic surface on the micro-array was shown to have a high degree of variability when using the leak test for gasket functionality. Variability of the membrane thickness, glass and adhesive coating, in addition to the laser process variability will result in an inconsistent cut width and depth on the hydrophobic ablated area. The hydrophobic ablated area is flatter than the non-ablated surface of the micro-array slide, however, variation in cut width and depth is observed. The raster cut will provide the flat surface required for applying the gasket in the hydrophic area on the micro-array slide. Vector cutting was added to the raster ablation cutting to improve the hydrophobic ablated area width and placement dimensions. Vector cutting along the inner and outer borders of the hydrophobic area improved ablated area dimension placement. The hydrophobic ablated zone was first etched with laser using rastering etching. Vector cutting with the laser defined the hydrophic ablation zone. In dual raster and vector cut samples, multiple vector cut lines were added within the ablated hydrophic zone.

TABLE 9
Rastering etching laser process settings

| | Settings |
|---|---|
| Raster cutting | |
| Power (%) | 100 |
| Speed (%) | 40-60 |
| Dots per inch (Hz) | 200 |
| Datum height (in) | 1.0 |
| Vector Cutting | |
| Power (%) | 15 |
| Speed (%) | 100 |
| Frequency (Hz) | 5000 |
| Datum height (in) | 1.0 |

TABLE 10
Rastering with vector cutting samples leak test results

| | | Average | |
|---|---|---|---|
| | | leakage | Standard |
| Example | Gasket Test | (%) | deviation |
| 7A | Raster etching and 2 vector lines | 9.38 | 7.98 |
| | establishing ablated border | | |
| 7B | Raster etching and 3 vector lines | 6.41 | 1.69 |
| | in ablated zone | | |
| 7C | Raster etching and 5 vector lines | 3.60 | 1.07 |
| | in ablated zone | | |

Measurements were made to determine the precision of both the placement and the internal dimensions of the raster cut hydrophobic ablated zone. This was done to ensure that the desired defined geometry was produced on the composite slide. The measurement methods are described in Example 3 above.

TABLE 11
Summary of type and functionality of ablated composite prototypes:

| | | | | Hydrophobic | |
|---|---|---|---|---|---|
| | | | | zone | |
| | | | | dimensional | |
| | | | | placement | |
| | | | | maximum offset | |
| | | | | variation in | |
| | | | | length(x) or | |
| | | | | width(y) (inches) | Hydrophilic zone |
| | | | Leak test | relative to | dimensional area |
| | | | variability | reference edge | maximum |
| | | | (std dev of | (axis).origin | variation length or |
| | | Leak test | percent | Expressed as | width (inches) |
| Example | | (% water | water | standard | expressed as a |
| No | Test slide | loss)) | loss)) | deviation | standard deviation |
| 1 | Control slide | 2.35 | 0.556 | N/A | N/A |
| 2 | Nylon composite slide | 100 | N/A | N/A | N/A |
| | (no ablation) | | | | |
| 3 | Hot die ablated | 3.02 | .296 | .005 | .004 |
| | composite slide | | | | |
| 4 | Knife edge hot die | 3.1 | 0.184 | .005 | .002 |
| | ablated composite slide | | | | |
| 5A | Laser vector ablated | 23.55 | 17.3 | .008 | .002 |
| | composite slide (1-line) | | | | |
| 5B | Laser Vector Ablated | 4.59 | 0.47 | .008 | .002 |
| | composite slide (3-line) | | | | |
| 5C | Laser Vector Ablated | 3.48 | 0.34 | .008 | .002 |
| | composite slide (6-line) | | | | |
| 6 | Laser Raster ablated | 9.57 | 12.8 | .009 | .015 |
| | composite slide | | | | |
| 7A | Laser Raster and vector | 9.38 | 7.98 | .008 | .002 |
| | ablated composite slide | | | | |
| 7B | Laser Raster and vector | 6.41 | 1.69 | .008 | .002 |
| | ablated composite slide | | | | |
| 7C | Laser Raster and vector | 3.60 | 1.07 | .008 | .002 |
| | ablated composite slide | | | | |

As is readily apparent from the above Table 11, it is clear that certain hydrophilic areas can be isolated on a representative composite microarray slide, such slide having a porous material surface. As can be seen, leak tests were performed in accordance with the methods described herein to determine the percentage of fluid leakage. In example 1, the operability of the gasket used in the test was tested and found that the gasket was quite efficient in retaining the fluid within the area designated.

In example 2, a nylon surfaced representative composite microarray slide was tested and found to be unsatisfactory in that about 100 percent of the fluid leaked or was lost during testing.

In examples 3-6, similar nylon surfaced representative composite microarray slides were tested and found to reduce the leakage rate to within acceptable standards of 10% or below with the exception of example 5A. In examples 3, 4, 5B, 5C 6 and 7A-C, the leak test results indicated that the innovation of the present disclosure was successful in meeting the 10% fluid leak target. Thus it should be evident that the processes for forming hydrophobic boundaries surrounding hydrophilic areas have proven extremely successful.

As can be seen in the above summary, the innovative ablation techniques applied to the composite slides result in well controlled, predetermined geometric shaped boundaries formed on the slides, and have the beneficial capabilities of providing zones for containing fluid, effectively forming barriers to prevent fluid leakage when used in conjunction with a sealing apparatus such as a gasket. The ablated zone(s) further have a hydrophobic characteristic, which beneficially help to direct or contain aqueous liquid to the more hydrophilic porous structure. The ablated zone(s) have well defined geometries, and (in conjunction with proper fixturing devices) can be placed reproduceably and accurately in predetermined locations on a representative composite slide, which results in an improved product useful for microarray applications.

While the shapes of the hydrophilic zones illustrated herein have been square or rectangular in shape, it should be understood that the innovations described herein are not limited to any specific shape and that all possible geometric shapes are believed possible in the practice of these innovations.

While the articles, apparatus and methods for making the articles contained herein constitute preferred embodiments of the invention, it is to be understood that the disclosure is not limited to these precise articles, apparatus and methods, and that changes may be made therein without departing from the scope of the disclosure which is defined in the appended claims.

1-20. (canceled)

21. Composite slide structures for micro analytical assay comprising:
a solid substrate;
a porous polymer membrane operatively connected to the solid substrate:
boundary structure, operatively formed on the porous polymer membrane side of the composite slide structure by the ablation of the porous polymer membrane by at least one laser, the boundary structure defining area having a predetermined shape on the surface of the porous polymer membrane, the boundary structure being effective to retain fluid within the area on the surface of the porous polymer membrane defined by the boundary structure.

22. The composite slide structures of claim 1, wherein the boundary structure formed by the laser ablation of the porous polymer membrane is operatively formed by laser vector cutting.

23. The composite slide structures of claim 1, wherein the boundary structure formed by the laser ablation of the porous polymer membrane is operatively formed by laser rastering cutting.

24. The composite slide structures of claim 1, wherein the boundary structure formed by the laser ablation of the porous polymer membrane is operatively formed by both laser vector cutting and laser rastering cutting.

25. The composite slide structures of claim 1, wherein the boundary structure formed is a loss of substantially all the polymer membrane at the point of laser ablation.

26. A composite device comprising:
a non-porous substrate;
a microporous membrane operatively connected to the non-porous substrate;
at least one predetermined shaped hydrophilic microporous membrane region containing tortuous channels and pores operatively positioned on the surface of the microporous membrane, and
at least one hydrophobic zone boundary surrounding the at least one predetermined shaped hydrophilic microporous membrane region such that fluid placed within the hydrophilic microporous membrane region is effectively retained therein by the at least one hydrophobic zone boundary, the at least one hydrophobic zone boundary being formed by the ablation of the microporous membrane by at least one laser.

27. The composite devise of claim 7 further comprising:
two or more separate predetermined shaped hydrophilic microporous membrane regions operatively positioned on the surface of the microporous membrane, wherein the hydrophobic zone boundary is shaped so that the hydrophobic zone boundary separates adjacent regions of the hydrophilic microporous membrane mounted on the substrate such that the fluid contained within one hydrophilic region does not cross the hydrophobic zone boundary into any adjacent hydrophilic microporous membrane region.

28. The composite devise of claim 7 wherein leakage across the hydrophobic zone boundary of fluids containing biological polymers operatively positioned on the surface of the composite microarray slide is at least substantially reduced, if not eliminated.

29. The composite devise of claim 7 wherein the at least one hydrophobic zone boundary is operatively formed by laser vector cutting.

30. The composite devise of claim 7 wherein the at least one hydrophobic zone boundary is operatively formed by laser rastering cutting.

31. A method of fabricating a composite device comprising the acts of:
providing a non-porous substrate;
providing a hydrophilic porous membrane containing tortuous channels and pores;
operatively connecting the non-porous substrate to the hydrophilic porous membrane; and
ablating the hydrophilic porous membrane utilizing at least one laser to operatively form at least one hydrophobic zone boundary on the surface of the hydrophilic porous membrane such that at least one predetermined shaped hydrophilic porous membrane region is formed thereby.

32. The method of claim 12 further comprising the act of:
ablating the hydrophilic porous membrane utilizing at least one laser to operatively form multiple hydrophobic zone boundaries on the surface of the hydrophilic porous membrane such that any adjacent region of hydrophilic porous membrane on the non-porous substrate is separated thereby.

33. The method of claim 12 wherein the at least one hydrophobic zone boundary operatively forming act comprises:
selectively ablating with the at least one laser selected areas of the pore structure of the hydrophilic porous membrane such that the selected areas of the pore structure of the hydrophilic porous membrane containing the pore structure are removed entirely from the non-porous substrate.

34. The method of claim 15 wherein the selectively ablating act comprises:
using the at least one laser on the once porous and hydrophilic porous membrane until the once porous and hydrophilic porous membrane becomes non-porous and hydrophobic.

35. The method of claim 15 wherein the selectively ablating act comprises:
using the at least one laser on the once porous and hydrophilic porous membrane until the once porous and hydrophilic porous membrane such that a non-porous film is formed on the non-porous substrate.

36. The method of claim 15 wherein the selectively ablating act comprises:
using the at least one laser on the once porous and hydrophilic porous membrane until the once porous and hydrophilic porous membrane such that there is a loss of substantially all the hydrophilic porous membrane at the point of ablation.

37. The method of claim 18 wherein the ablating the hydrophilic porous membrane utilizing at least one laser to form at least one hydrophobic zone boundary operatively forming act comprises:
laser rastering cutting.

38. The method of claim 18 wherein the ablating the hydrophilic porous membrane utilizing at least one laser to form the at least one hydrophobic zone boundary operatively forming act comprises:
both laser vector cutting and rastering cutting.
